(19) United States
(12) Patent Application Publication
(10) Pub. No.: US 2017/0220688 A1
(43) Pub. Date: Aug. 3, 2017

(54) Method for Launching Web Search on Handheld Computer

(71) Applicant: Ping-Shun Zeung, Taipei City (TW)

(72) Inventor: Ping-Shun Zeung, Taipei City (TW)

(73) Assignee: I/O INTERCONNECT, LTD., Santa Ana, CA (US)

(21) Appl. No.: 15/012,830

(22) Filed: Feb. 1, 2016

(51) Int. Cl. G06F 17/30; G06F 3/16; H04W 76/02

(52) U.S. Cl. CPC G06F 17/30867; H04W 76/023; G06F 3/167

(57) ABSTRACT

A method for remotely launching web search on a smartphone is disclosed. The method includes the steps of: a) wirelessly connecting a remote control with a microphone to the smartphone; b) opening a searching text input box; c) enabling the searching text input box with a voice IME (input method editor); d) speaking a word to be searched to the remote control; e) sending the voiced word to the handheld computer; f) transmitting the voiced word to a search engine with a speech recognition function through internet; and g) the search engine transmitting a search result to the smartphone.

### BACKGROUND OF THE INVENTION

1. Technical Field The invention relates to operations of a handheld computer such as a smartphone or tablet, particularly to web search using a handheld computer and a remote control.

2. Related Art

Handheld computers, such as smartphones and tablets, have become essential for most people. The most important function of handheld computers is the ability to connect internet. Of course, almost all users of handheld computers have the need to connect their handheld computers to internet. Meanwhile, some users also connect their handheld computers to a personal computer or a TV set for integration of systems or largely displaying. As a result, the use's handheld computer may be out of his or her reach. The user must pick up his or her handheld computer to operate it when he or she wants to make web search. It is inconvenient for users because web search is a frequently needed operation. That is a fly in the ointment for most users. However, there is no solution on the market yet.

### SUMMARY OF THE INVENTION

An object of the invention is to provide a method for launching web search on a handheld computer, which can directly launch a search engine on a handheld computer through a remote control by using voice.

To accomplish the above said object, the method for launching a web search engine on a handheld computer, includes the steps of:

a) wirelessly connecting a remote control with a microphone to a handheld computer;

b) opening a searching text input box;

c) enabling the searching text input box with a voice IME (input method editor);

d) speaking a word to be searched to the remote control;

e) sending the voiced word to the handheld computer;

f) transmitting the voiced word to a search engine with a speech recognition function through internet; and

g) the search engine transmitting a search result to the handheld computer.

### BRIEF DESCRIPTION OF THE DRAWINGS

FIG. 1 is a schematic view of hardware arrangement of the invention; and

FIG. 2 is a flowchart of the method of the invention.

### DETAILED DESCRIPTION OF THE INVENTION

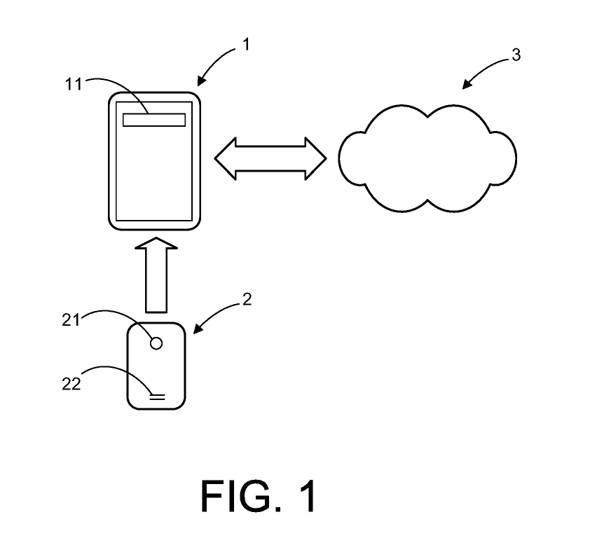

Please refer to FIG. 1. The invention provides a method for launching web search on a handheld computer 1. The handheld computer 1 may be based upon an Android operating system. Of course, the handheld computer 1 is capable of connecting internet directly or indirectly. A remote control 2 can be wirelessly connected with the handheld computer 1. The remote control 2 is provided with a key 21 and a microphone 22.

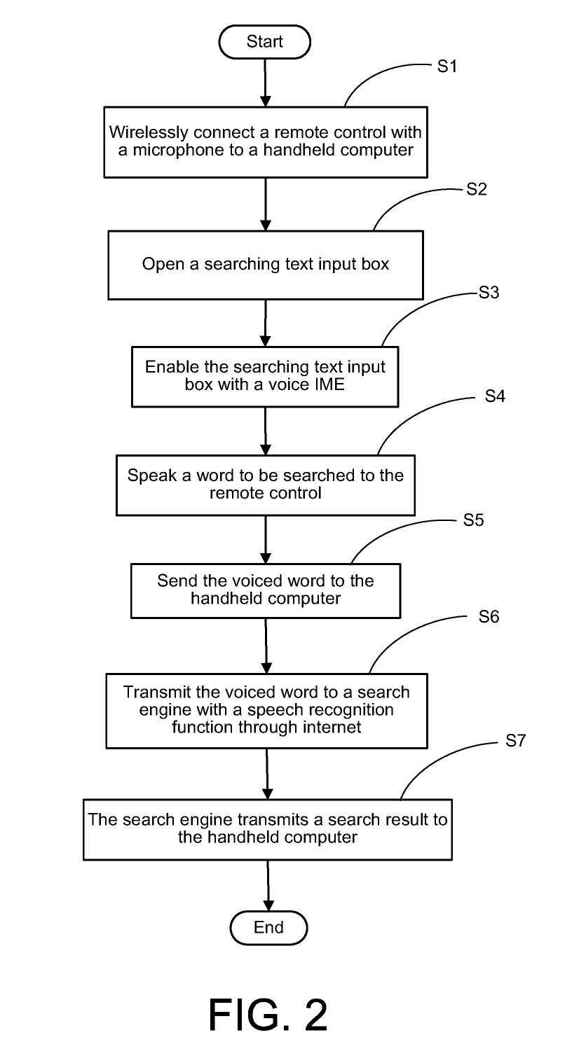

Please refer to FIG. 2, which shows a flowchart of the method of the invention. In step S1, the handheld computer 1 is wirelessly connected to the remote control 2. The wireless connection between the handheld computer 1 and the remote control 2 may be implemented by a BLUETOOTH or Wi-Fi communication protocol. The remote control 2 can be put any place near a user. Additionally, the handheld computer 1 is installed with a proprietary software application with a voice IME (input method editor). Then a communication channel is created between the handheld computer 1 and the remote control 2.

In step S2, a searching text input box 11 is opened on the handheld computer 1 by a user. In step S3, the proprietary software application in the handheld computer 1 enables the searching text input box 11 with a voice IME for being input with voice.

In step S4, a user speaks a word to be searched to the remote control 2, so that the voiced word is received by the microphone 22 of the remote control 2. In detail, the voiced word is received after pressing the key 21 of the remote control 2. Next, in step S5, the remote control 2 sends the voiced word to the handheld computer 1 through the wireless communication channel. In step S6, the proprietary software application in the handheld computer 1 transmits the voiced word received to a search engine with a speech recognition function through internet. For example, this search engine is the Google servers. After the search engine receives the voiced word to be searched, it will recognize the voiced word to be a textual word and proceed with a search for the textual word. After that, a search result will be generated.

Finally, in step S7, the search engine 3 transmits the search result to the handheld computer 1. Accordingly, the user can view the search result on the handheld computer 1.

In sum, by the method of the invention, a user can obtain a search result remotely from his or her handheld computer only by pressing a key and speaking a word to be searched. This will be very helpful and convenient for those users who connect their handheld computers to a personal computer or a TV set.

It will be appreciated by persons skilled in the art that the above embodiment has been described by way of example only and not in any limitative sense, and that various alterations and modifications are possible without departure from the scope of the invention as defined by the appended claims.

What is claimed is:

1. A method for launching web search on a handheld computer, comprising:
a) wirelessly connecting a remote control with a microphone to the handheld computer;
b) opening a searching text input box;
c) enabling the searching text input box with a voice IME (input method editor) ;
d) speaking a word to be searched to the remote control;
e) sending the voiced word to the handheld computer;
f) transmitting the voiced word to a search engine with a speech recognition function through internet; and
g) the search engine transmitting a search result to the handheld computer.

2. The method of claim 1, wherein the step d) is performed after pressing a key of the remote control.

3. The method of claim 2, wherein a connection between the handheld computer and the remote control is a BLUETOOTH or Wi-Fi communication protocol.
